(19) United States
(12) Patent Application Publication
(10) Pub. No.: US 2025/0379777 A1
(43) Pub. Date: Dec. 11, 2025

(54) PHASE JUMP HANDLING FOR DMRS SHARING AND LONG SLIV DMRS FOR 6G PXSCH

(71) Applicant: QUALCOMM Incorporated, San Diego, CA (US)

(72) Inventors: Chih-Hao LIU, San Diego, CA (US); Jing SUN, San Diego, CA (US); Raviteja PATCHAVA, San Diego, CA (US)

(21) Appl. No.: 18/737,873

(22) Filed: Jun. 7, 2024

(51) Int. Cl. H04L 27/26; H04L 5/00; H04W 72/0453; H04W 72/1268; H04W 72/20

(52) U.S. Cl. CPC H04L 27/2613; H04L 5/0051; H04W 72/0453; H04W 72/1268; H04W 72/20

(57) ABSTRACT

This disclosure provides systems, methods and apparatuses for compensating for a phase jump in a gap of a transmission received via multiple transmit time intervals (TTIs). A wireless node such as a user equipment obtains a configuration of one or more symbol locations of one or more reference signals before or after a gap during which a phase jump can occur in a transmission to be received via multiple TTIs. The wireless node may obtain an indication of one or more symbol locations associated with the gap during which a phase jump will occur in the transmission to be received via multiple TTIs. The wireless node estimates the phase jump during the gap based on one or more reference signals located before or after the gap.

### TECHNICAL FIELD

The present disclosure relates to wireless communications including phase jumps in physical shared channels (PxSCH) with demodulation reference signal sharing and long start and length indicator values (SLIVs).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories storing computer-executable instructions; and one or more processors configured to execute the computer-executable instructions, individually or in combination, to cause the apparatus to: obtain a configuration of one or more symbol locations of one or more reference signals before or after a gap during which a phase jump can occur in a transmission to be received via multiple transmission time intervals (TTIs); and estimate the phase jump during the gap based on the one or more reference signals located in the one or more symbol locations before or after the gap.

In some aspects, the techniques described herein relate to an apparatus for wireless communication, including: one or more memories storing computer-executable instructions; and one or more processors configured to execute the computer-executable instructions, individually or in combination, to cause the apparatus to: output, for transmission to a user equipment (UE), a configuration of one or more symbol locations of one or more reference signals before or after a gap during which a phase jump can occur in a transmission via multiple transmission time intervals (TTIs); and output, based on the gap, one or more reference signals at the symbol locations before or after the gap for estimating the phase jump during the gap.

In some aspects, the techniques described herein relate to a method of wireless communications at a user equipment (UE), including: obtaining a configuration of one or more symbol locations of one or more reference signals before or after a gap during which a phase jump can occur in a transmission to be received via multiple transmission time intervals (TTIs); and estimating the phase jump during the gap based on the one or more reference signals located in the one or more symbol locations before or after the gap.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram illustrating an example of a physical or logical gap in a transmission.

FIG. 6 is a diagram illustrating an example of an indication of a physical or logical gap in a transmission.

FIG. 7 is a diagram illustrating an example of a transmission including a periodic glue reference signal.

FIG. 8 is a diagram illustrating an example of a transmission including a glue reference signal adjacent to a gap in the transmission.

FIG. 9 is a diagram illustrating an example of a transmission including a dynamic demodulation reference signal (DMRS) adjacent to a gap in the transmission.

FIG. 10 is a message diagram showing various messages to facilitate channel estimation for transmissions including a gap.

FIG. 11 is a conceptual data flow diagram illustrating the data flow between different means/components in an example network entity including gap identification component.

FIG. 12 is a conceptual data flow diagram illustrating the data flow between different means/components in an example UE including a phase jump component.

FIG. 13 is a flowchart of an example method for a wireless node such as a UE to estimate a phase jump of a transmission including a gap.

FIG. 14 is a flowchart of an example method for a wireless node such as a network entity to facilitate phase estimation for transmissions including a gap.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

In wireless communications, such as 5G, time may be divided into units such as frames, sub-frames, slots, and symbols. 5G standards allow for repeated physical uplink shared channel (PUSCH) transmissions with multiple segments of back-to-back symbols. The repetitions take different redundancy versions of a PUSCH transmission and each repetition segment does not cross a slot boundary. Such transmissions may extend PUSCH coverage.

Transmissions that span a slot boundary have potential to increase coverage and/or reduce overhead associated with scheduling. For example, a long start and length indicator value (SLIV) that indicates a length of a transmission greater than a slot may allow allocation of physical shared channel (PxSCH) transmissions across a slot boundary. PxSCH may include, for example, physical downlink shared channel (PDSCH), physical uplink shared channel (PUSCH), or physical sidelink shared channel (PSSCH). A transmission with length greater than a slot may simplify designs to extend coverage and/or reduce demodulation reference signal (DMRS) overhead. For instance, a more uniform DMRS pattern may be applied for a given Doppler effect. For channel estimation in a Doppler channel, a group of DMRS symbols can be exploited to interpolate the channel within a time span or channel estimate window. Causal cross slot DMRS combining may include buffering DMRS or channel estimates for use in a later transmit time interval (TTI). Non-causal cross slot DMRS combining may include waiting for a DMRS in a next front-loaded TTI to use interpolation to estimate symbols in the previous TTI.

One issue with transmissions that span more than one slot is the possibility of a physical or logical gap in the transmission that causes a phase jump. For example, the transmitter may undergo a switch from transmit (Tx) to receive (Rx) and back to Tx between slots. As another example, a radio frequency (RF) reconfiguration may cause a phase jump. Similarly, the receiver may undergo a Rx/Tx/Rx switch or an RF reconfiguration which may cause a phase jump. The receiver may compensate for a phase jump before performing DMRS combining or joint channel estimation.

In an aspect, the present disclosure provides for a configuration of reference signals to allow accurate estimation of a phase jump in a transmission to be received via multiple TTIs. For example, a first wireless node such as a network entity or transmitting user equipment (UE) may provide the configuration of one or more symbol locations of one or more symbol locations of one or more reference signals before or after a gap during which a phase jump can occur. The first wireless node can also provide an indication of one or more symbol locations associated with the gap during which the phase jump will occur in the transmission via multiple TTIs. A second wireless node such as a receiving UE may obtain the indication and estimate the phase jump during the gap based on the one or more reference signals located before or after the gap.

By estimating the phase jump during the gap, the second wireless node is able to compensate for the gap and estimate the channel using DMRS combining or joint channel estimation. Accordingly, the techniques disclosed herein provide for increased coverage using long transmissions and reduce overhead.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

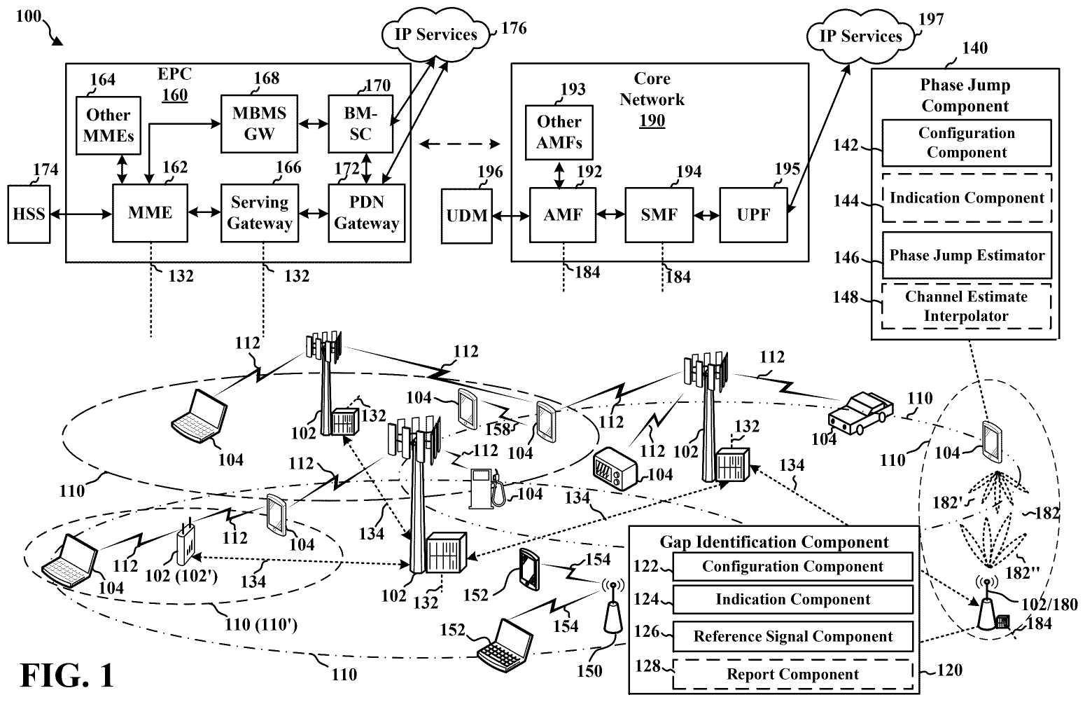

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUS may be implemented within an edge RAN node, and in some aspects, one or more DUs may be co-located with a CU, or may be geographically distributed throughout one or multiple RAN nodes. The DUs may be implemented to communicate with one or more RUs.

In some implementations, one or more of the UEs 104 include a phase jump component 140 configured to compensate for a phase jump in a transmission via multiple TTIs. The phase jump component 140 includes an configuration component 142 and a phase jump estimator 146, and may optionally include a an indication component 144 and/or a channel estimate interpolator 148. The configuration component 142 is configured to obtain a configuration of one or more symbol locations of one or more reference signals before or after a gap during which a phase jump can occur in a transmission to be received via multiple transmission time intervals (TTIs). The indication component 144 may be configured to obtain an indication of one or more symbol locations associated with the gap during which the phase jump will occur in a transmission to be received via the multiple TTIs. The phase jump estimator 146 is configured to estimate the phase jump during the gap based on one or more reference signals located before or after the gap. The phase jump estimator 146 may be configured to interpolate a channel estimate based at least in part on the estimated phase jump.

In some implementations, one or more of the network entities such as a base station 102 include a gap identification component 120 configured to facilitate phase estimation for transmissions including a gap. The gap identification component 120 includes a configuration component 122 and a reference signal component 126. The gap identification component 120 may optionally include an indication component 124 and a report component 128. The configuration component 122 is configured to output, for transmission to a user equipment (UE), a configuration of one or more symbol locations of one or more reference signals before or after a gap during which a phase jump can occur in a transmission via multiple transmission time intervals (TTIs). The indication component 124 may be configured to output, for transmission to the UE, an indication of one or more symbol locations associated with the gap during which a phase jump will occur in the transmission via multiple TTIs. The reference signal component 126 is configured to output, based on the gap, one or more additional reference signals located before or after the gap for estimating the phase jump during the gap.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as SI interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHZ-300 GHZ) which is identified by the International Telecommunications Union (ITU) as a “millimeter wave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

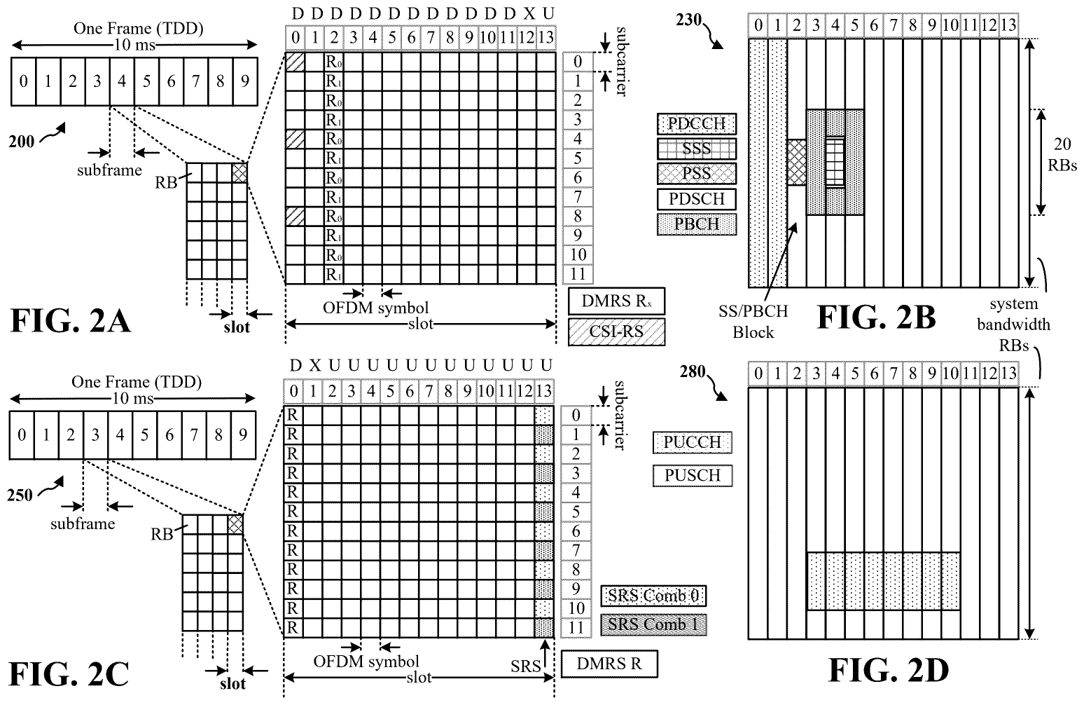

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rx for one particular configuration, where 100x is the port number, but other DMRS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DMRS (indicated as R for one particular configuration, but other DMRS configurations are possible) for channel estimation at the base station. The UE may transmit DMRS for the physical uplink control channel (PUCCH) and DMRS for the physical uplink shared channel (PUSCH). The PUSCH DMRS may be transmitted in the first one or two symbols of the PUSCH. The PUCCH DMRS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

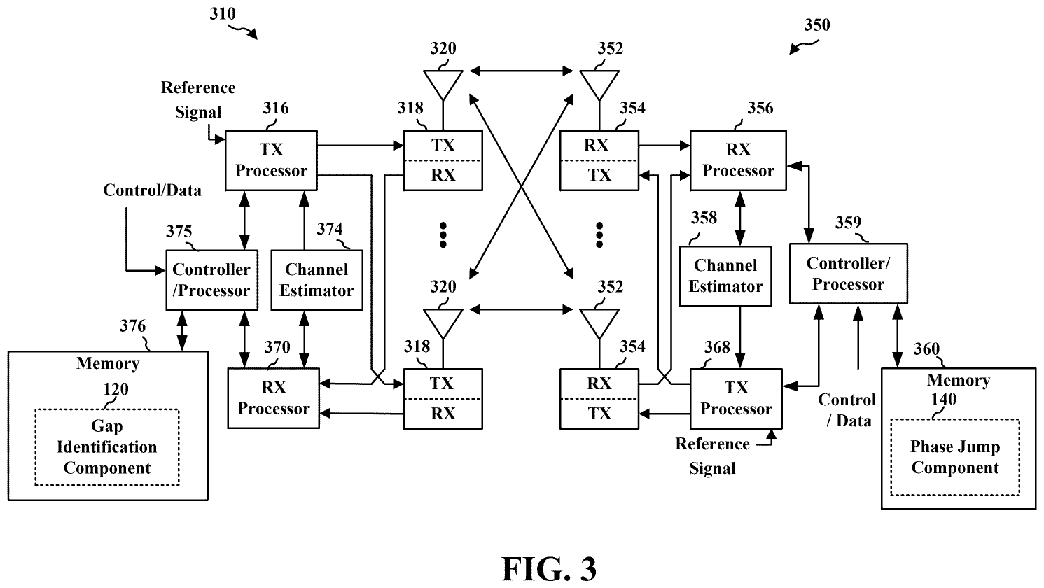

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the phase jump component 140 of FIG. 1. For example, the memory 360 may include executable instructions defining the phase jump component 140. The TX processor 368, the RX processor 356, and/or the controller/processor 359 may be configured to execute the phase jump component 140.

At least one of the TX processor 316, the RX processor 370, and the controller/processor 375 may be configured to perform aspects in connection with the gap identification component 120 of FIG. 1. For example, the memory 376 may include executable instructions defining the gap identification component 120. The TX processor 316, the RX processor 370, and/or the controller/processor 375 may be configured to execute the gap identification component 120.

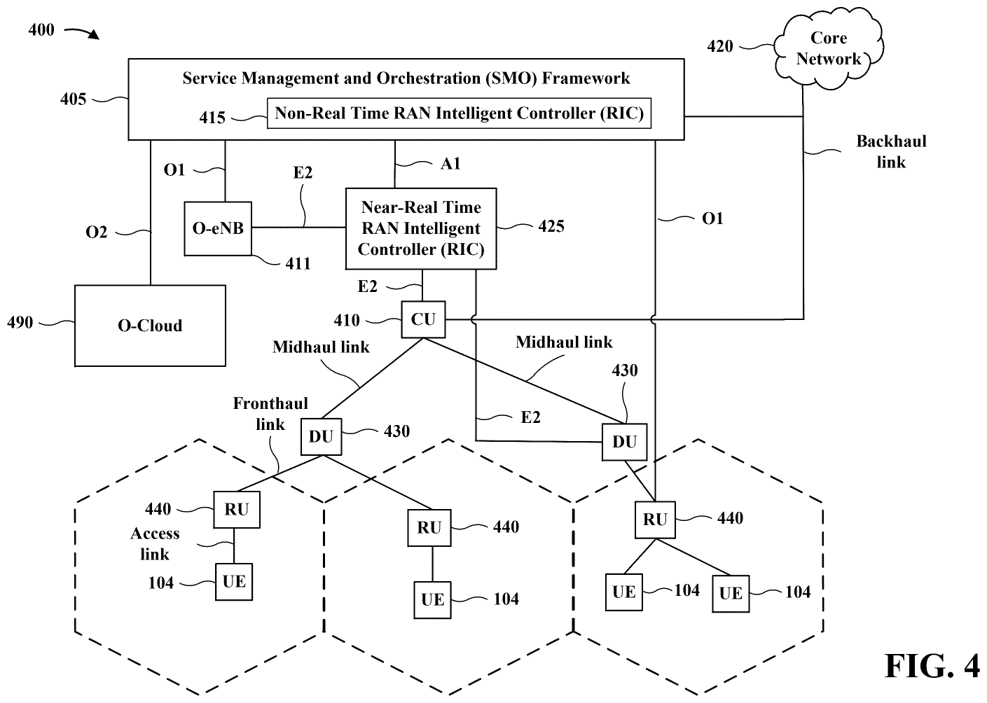

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

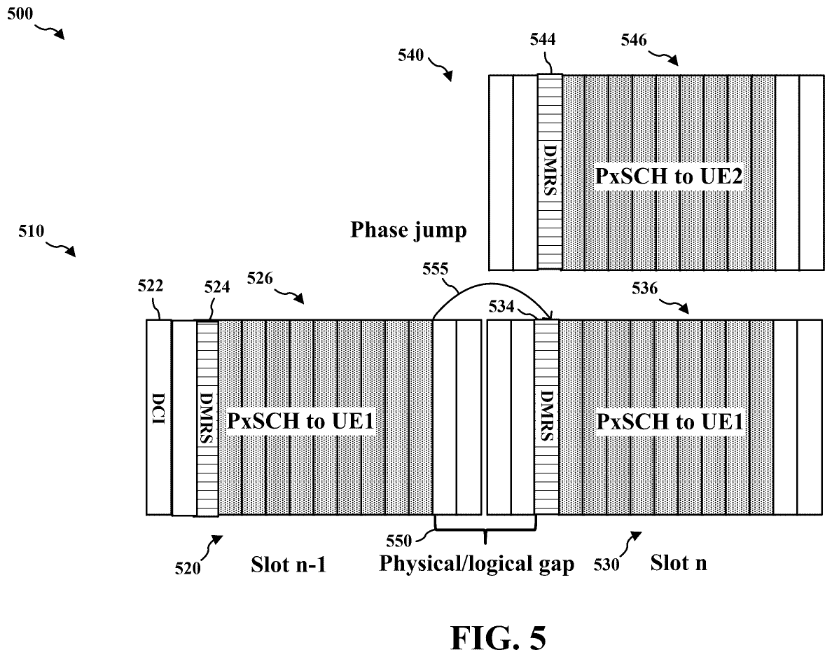

FIG. 5 is a diagram 500 illustrating an example of a physical or logical gap 550 in a transmission 510. For example a first UE (e.g., UE1) may be scheduled for DMRS combining over multiple TTIs or a long SLIV across multiple slots 520 and 530. For instance, the transmission 510 may be scheduled by a DCI 522 and may include DMRS 524 and 534 in the third symbol of each slot. The transmission may be a PxSCH 526 such as a PDSCH.

For DMRS combining over multiple TTIs or long SLIV across multiple slots, there is a chance that the transmitter undergoes Tx/Rx/Tx switch, Tx gap, or RF reconfiguration. Similarly, the receiver may undergo Rx/Tx/Rx switch and RF reconfiguration. Hence, at the receiver, even when the Tx maintains the same precoder across two time segments, which are separated by physical/logical gap 550 (e.g., due to Tx/RX switch, RF reconfig), there could be a phase jump 555 between the two time segments.

For instance, it may seem simple to maintain the phase continuity if a transmitter is transmitting a data burst toward a single UE. However, if the transmitter starts to transmit to one or more other UEs in the middle of the burst, the transmitter may need to increase the Tx power and the phase continuity may not be guaranteed. For example, when the transmitter starts transmission 540 including a DMRS 544 and PxSCH 546 in slot n 530 to a second UE (UE2), the transmit power may change, resulting in a phase jump in the transmission 510. So, across those TTI gaps, the Tx may or may not maintain the phase continuity depending on the scheduling decision and RF configuration. Similarly, when the receiver is receiving a data burst toward it, the receiver may also do RF reconfiguration if the receiver starts to receive another transmission, e.g., another sidelink transmission in the middle of the data burst causes automatic gain control (AGC) gain change.

The phase jump 555 refers to a change in phase at either a transmitter or a receiver. The phase jump may be in addition to phase changes due to channel conditions such as Doppler. For example, there may be phase changes between the DMRS 524 and the DMRS 534 due to Doppler. In DMRS combining, the UE may interpolate the channel estimate to account for such phase changes. The phase jump 555, however, may change the phase across all resource blocks, which may result in inaccurate interpolation.

In an aspect, if the receiver knows where those physical/logical gaps are, phase compensation can be performed per time segment before DMRS combining or joint channel estimation to remove the phase jump. For low Doppler speed, it is possible that the receiver can figure out the phase jump from one DMRS from each of two time segments. That is, with low Doppler, most of the phase change may be attributed to the phase jump. It is also possible that the receiver may refrain from DMRS combining in low Doppler scenarios to avoid the impact of the phase jump. This approach may result in some performance degradation due to loss of DMRS combining. However, simple phase jump estimation and refraining from DRMS combining may not be feasible for higher Doppler speed where the performance degradation would be greater. Accordingly, there may be a need to update the reference signal pattern for estimation of the phase jump to allow phase compensation.

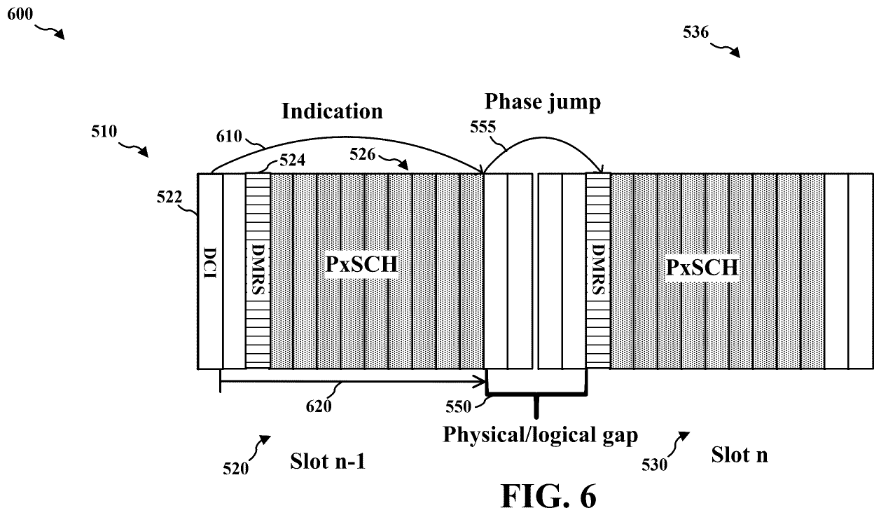

FIG. 6 is a diagram 600 illustrating an example of an indication 610 of a physical or logical gap in a transmission 510. The indication 610 allows coordination of gap locations including phase jump between the transmitter and the receiver.

For phase jumps 555 introduced at a network entity, the scheduler of the network entity may dynamically indicate the location of the phase jump 555. For instance, when the network entity makes a scheduling decision that will cause the phase jump 555 such as adding the transmission 540, the network entity may indicate the symbol location of the physical/logical gap 550 where the phase jump may occur. In some implementations, the indication 610 may be dynamically indicated via a downlink control information (DCI) 522. For instance, the indication 610 may be causal, i.e., carried by the DCI 522 in the TTI prior to the gap or the DCI at the beginning of the data burst (e.g., including the long SLIV). The indication 610 may include an offset 620 with respect to the DCI 522 that indicates a number of symbols between the DCI 522 and the gap 550. In some implementations, for example, where semi-persistent scheduling or configured grants arc likely to cause phase jumps, the network entity may configure a location via RRC configuration.

For phase jumps 555 introduced by a UE, the UE may need to report a likely phase jump via RRC messaging. The network entity may then account for phase jumps in scheduling decisions and/or indicate that the UE is scheduled for a transmission with a likely phase jump.

The indication 610 allows the receiver to identify phase jumps 555. In some implementations, the receiver may estimate the phase jump based on channel estimates on the DMRS 524 and 534. For instance, the channel estimates may include a phase estimate θ₀ corresponding to DMRS 524 and phase estimate θ₁ corresponding to DMRS 534. The difference (θ₁−θ₀) includes both the phase jump at the gap 550 and the Doppler shift.

In cases with high Doppler, however, the phase jump cannot be easily distinguished. In particular, if the two reference signals are too far away from the gap 550 including the phase jump 555, the Doppler has a relatively greater impact, and the phase jump 555 cannot be estimated. In an aspect, extra reference signals may be configured before and/or after the gap 550 to allow estimation of the phase jump 555.

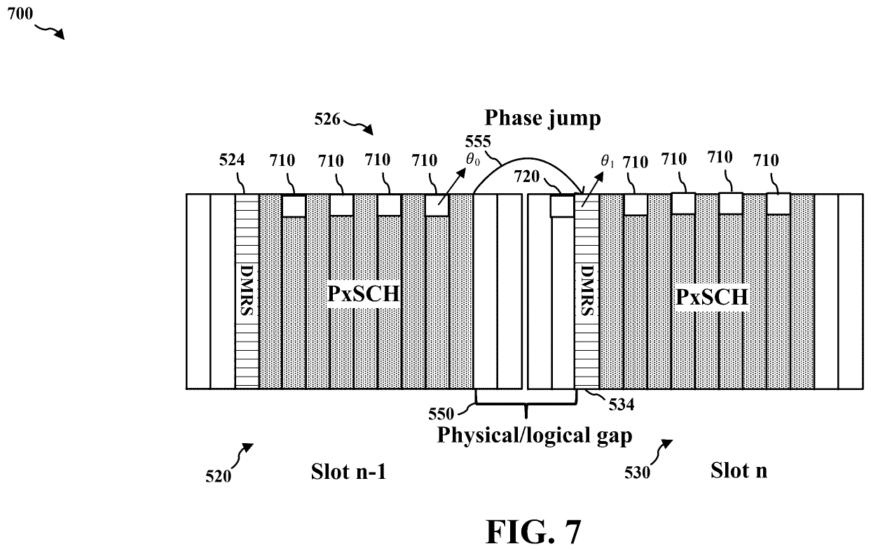

FIG. 7 is a diagram 700 illustrating an example of a transmission including a glue reference signal (gRS) 710. The gRS 710 may have a sequence based on a demodulation reference signal (DMRS) of the transmission 510 and be associated with fewer resource blocks than the DMRS 524. For instance, because the phase jump 555 equally affects all resource blocks, a single resource block may be used to estimate the phase jump 555. In some implementations, the gRS 710 may be transmitted on one or more configured symbol locations. Once the gap including the phase jump is identified, the receiver can estimate the phase jump exploiting the two closest DMRS 524, 534 or gRS 710 across the gap 550. For example, as illustrated, θ₁−θ₀ may be calculated based on a glue RS 710 that is closer to the gap 550 than the DMRS 524. Because the quantity of symbols between the gRS 710 and the DMRS 534 is smaller, the Doppler shift component in the estimated phase jump is small and can be ignored.

In some implementations, a pattern of the glue RS 710 may be based on a DMRS pattern. For example if there is no DMRS on one side of a gap, the gRS 710 may be inserted into the transmission via a configuration of the gRS 170. If there is no DMRS on both sides of the gap, the gRS 710 can be inserted on both sides of the gap. For instance, the gRS 710 may be configured with a pattern such that a quantity of symbols between the gRS 710 or the DMRS 524 before the gap and a last symbol of the transmission before the gap 550 is less than or equal to a threshold value. Similarly, where the DMRS 534 is not front-loaded in the slot 530, a gRS 720 may be inserted prior to the DMRS 534.

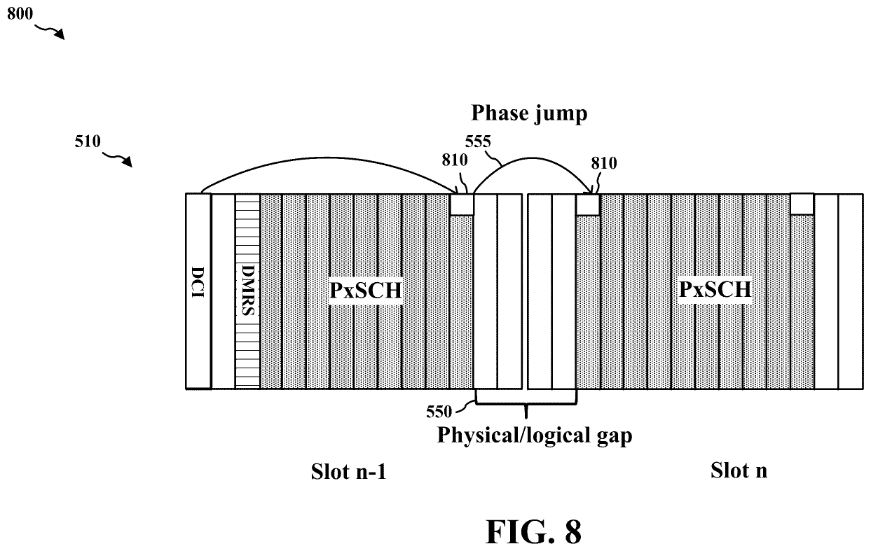

FIG. 8 is a diagram 800 illustrating an example of a transmission including a glue reference signal (gRS) 810 adjacent to a gap 550 in the transmission 510. The location of the gRS 810 may reduce the overhead of the gRS 710 in FIG. 7 while allowing similar phase jump estimation. For example, the gRS 810 may be only inserted around the gap 550 (e.g., in the last symbol of the transmission prior to the gap 550 and the first symbol of the transmission after the gap 550. If the PxSCH 536 already includes a DMRS 534 in the first symbol after the gap 550, the gRS 810 may be omitted. In some implementations, the DMRS 534 is at least a threshold quantity of symbols away from the gap 550, the gRS 810 may be included after the gap 550. The threshold quantity of symbols may be configured by RRC. The gRS 810 being adjacent to the gap 550 allows direct determination of the phase jump as θ₁−θ₀.

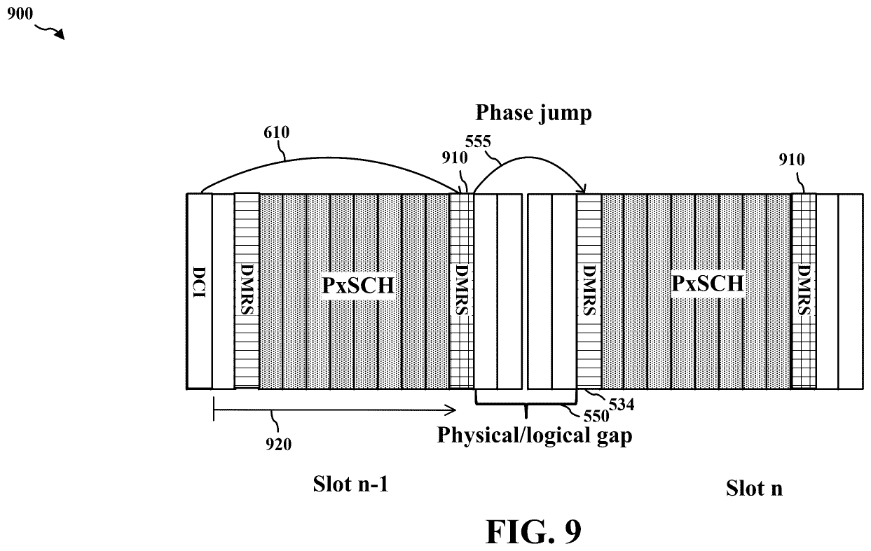

FIG. 9 is a diagram 900 illustrating an example of a transmission including a dynamic DMRS 910 adjacent to a gap 550 in the transmission 510. The dynamic DMRS 910 may be an additional DMRS to the DMRS 524, 534, which may be scheduled based on a DMRS pattern associated with a first DMRS configuration. The dynamic DMRS 910 may be configured with a second or additional DMRS pattern.

In some implementations, the receiver may be configured with an additional DMRS pattern that is activated by the indication 610. If there is no potential phase jump 555 around the gap 550, the symbols may be used to transmit data with no additional overhead for the dynamic DMRS 910. If there is a potential phase jump 555 across the gap 550 indicated by the DCI 522, the same DCI 522 or indication 610 can indicate the dynamic DMRS 910. For instance, the same field that indicates the phase jump 555 may indicate a DMRS 910 in the symbol before the gap 550. Alternatively, there may be an independent field that indicates whether the dynamic DMRS 910 is present.

In some implementations, the DCI 522 may dynamically configure the dynamic DMRS 910 by indicating the presence and/or offset 920 of the dynamic DMRS 910 with respect to the DCI 522. For example, the offset 920 may indicate a quantity of symbols between the DCI 522 and the dynamic DMRS 910. In some implementations, the use of the offset 920 may provide flexibility for phase jumps 555 due to logical gaps that can occur in any location (not just at slot boundaries).

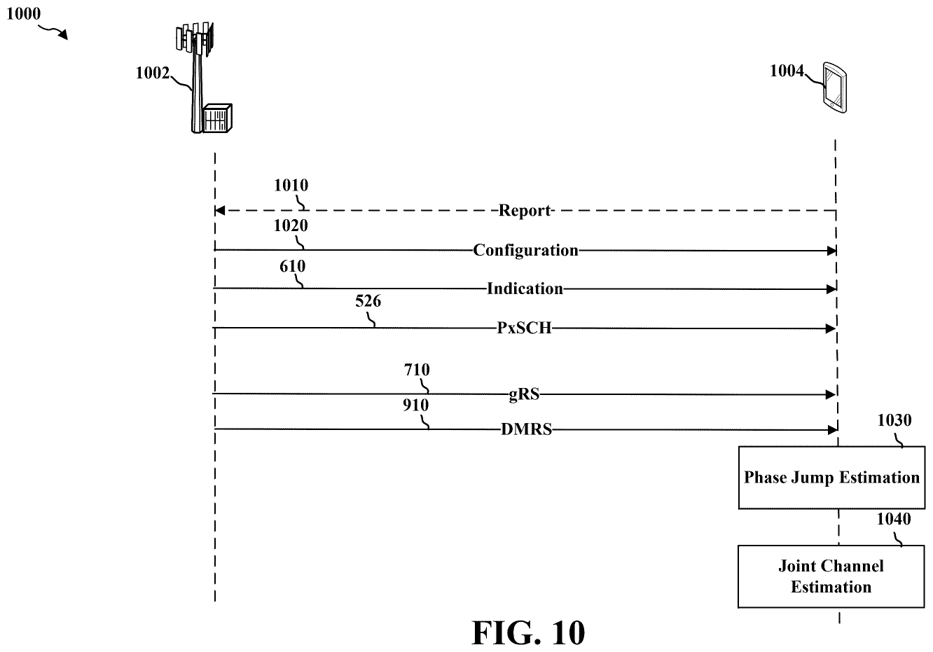

FIG. 10 is a message diagram 1000 showing various messages to facilitate channel estimation for transmissions including a gap. A first wireless node 1002 is illustrated as a base station but may be another transmitting node such as a network entity or, in the case of sidelink or uplink transmissions, a UE. A second wireless node 1004 is illustrated as a UE but may be another receiving node such as a network entity in the case of uplink transmissions.

In some implementations, the second wireless node 1004 outputs a report 1010 of another scheduled transmission. For example, when the second wireless node 1004 is a UE, the second wireless node may be scheduled by a third wireless node (not shown) for sidelink communications that may cause a phase jump at the second wireless node 1004. The report 1010 may inform the first wireless node 1002 of the timing of such potential phase jumps. In some implementations, the report 1010 is an RRC message.

The first wireless node 1002 outputs a configuration 1020 of one or more symbol locations of one or more reference signals before or after a gap during which a phase jump can occur in a transmission to be received via multiple TTIs. For example, the configuration 1020 may be an RRC message, a MAC-CE, or a DCI. For instance, an RRC message may indicate a second DMRS pattern in addition to a DMRS pattern of DMRS 524, 534 for the dynamic DMRS 910. An RRC message may indicate a pattern of the gRS 710. A MAC-CE may indicate activation or deactivation of a DMRS pattern or pattern of the gRS 710.

The first wireless node 1002 transmits the indication 610 of one or more symbol locations associated with a gap during which a phase jump will occur in a transmission to be received via multiple TTIs. For example, the first wireless node 1002 may transmit the indication 610 within control information (e.g., DCI) in a TTI prior to the gap 550. In some implementations, the indication 610 includes an offset 620 with respect to the control information. For example, the offset 620 may indicate the location of the gap 550. In some implementations, the first wireless node 1002 transmits the indication 610 after obtaining the report 1010 from the second wireless node 1004. For instance, the indication 610 may be in response to the report 1010 and/or may indicate a phase jump 555 due to a transmission scheduled for the second wireless node 1004.

The first wireless node 1002 outputs the PxSCH 526, 536 via multiple TTIs. The PxSCH transmission includes the gap 550. The second wireless node 1004 obtains the PxSCH transmission and can identify whether the gap 550 includes a phase jump 555 based on the indication 610. The second wireless node 1004 can compensate for the phase jump 555 when the phase jump is present.

In some implementations, the first wireless node 1002 transmits the gRS 710, 720, or 810. The gRS 710, 720, or 810 may be located in symbols close to the gap 550 to assist with estimating the phase jump. For example, the symbols may be indicated by the configuration 1020.

In some implementations, the first wireless node 1002 transmits the DMRS 910. The DMRS 910 may be a dynamic DMRS that is transmitted based on the presence of the phase jump 555. The DMRS 910 may be in addition to a configured DMRS (e.g., DMRS 524, 534) that is included in the transmission 510 regardless of a phase jump 555.

The second wireless node 1004 may perform phase jump estimation 1030. For example, the second wireless node 1004 may estimate the phase jump 555 when the indication 610 indicates that the phase jump 555 is present in the gap 550. In some implementations, the second wireless node 1004 may estimate the phase jump 555 as θ₁−θ₀. θ₀ is measured on the last reference signal before the gap 550, and θ₁ is measured on the first reference signal after the gap 550.

The second wireless node 1004 may perform joint channel estimation 1040 based on multiple DMRSs and the estimated phase jump. For example, the second wireless node 1004 may compensate for the phase jump before interpolating between the multiple DMRSs to estimate the channel on each symbol.

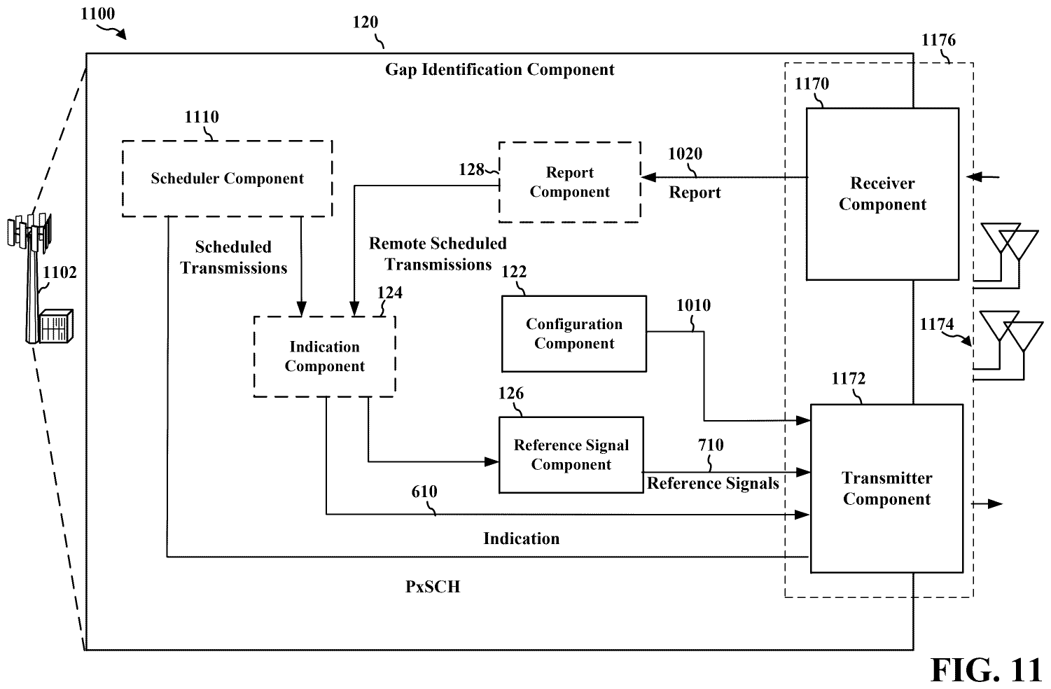

FIG. 11 is a conceptual data flow diagram 1100 illustrating the data flow between different means/components in an example wireless node 1102 including a gap identification component 120. For example, the wireless node 1102 may be an example of a wireless node such as the base station 102 (FIG. 1), another network entity, or another UE including the gap identification component 120. The gap identification component 120 may be implemented by the memory 376 and the TX processor 316, the RX processor 370, and/or the controller/processor 375 of FIG. 3. For example, the memory 376 may store executable instructions defining the gap identification component 120 and the TX processor 316, the RX processor 370, and/or the controller/processor 375 may execute the instructions.

The wireless node 1102 may include a receiver component 1170, which may include, for example, a radio frequency (RF) receiver for receiving the signals described herein. The wireless node 1102 may include a transmitter component 1172, which may include, for example, an RF transmitter for transmitting the signals described herein. The transmitter component 1172 may output RF signals to one or more antennas 1174. In an aspect, the receiver component 1170 and the transmitter component 1172 may be co-located in a transceiver 1176, which may correspond to the TX/RX 318 in FIG. 3.

As discussed with respect to FIG. 1, the gap identification component 120 may include the configuration component 122, the indication component 124, and the reference signal component 126. In some implementations, the gap identification component 120 may include the report component 128 and/or a scheduler component 1110.

The receiver component 1170 may receive signals from a UE 104. For example, the receiver component 1170 may receive report 1010. The receiver component 1170 may output the report 1010 to the report component 128.

The configuration component 122 is configured to output, for transmission to a UE, a configuration 1020 of one or more symbol locations of one or more reference signals before or after a gap during which a phase jump can occur in a transmission via multiple TTIs. In some implementations, the configuration 1020 may be a static configuration that indicates a pattern of the symbol locations of the gRS 710 or the dynamic DMRS 910. In some implementations, the configuration 1020 may include a dynamic indication of the reference signals. For instance, the configuration 1020 may be control information that indicates a symbol location of a gRS 810 or dynamic DMRS 910. The configuration component 122 may output the configuration 1020 for transmission via the transmitter component 1172 and/or the transceiver 1176.

The scheduler component 1110 is configured to schedule transmissions 510 for transmission via multiple TTIs. For example, the transmission 510 may include the PxSCH 526, 536. The scheduler component 1110 may output scheduling information for the scheduled transmissions to the indication component 124. In some implementations, the scheduling information may also include information regarding Tx/Rx/Tx switching and RC reconfigurations. The scheduler component 1110 may output the data for the scheduled transmissions as a PxSCH for transmission via the transmitter component 1172.

The report component 128 may obtain the report 1010 via the receiver component 1170. The report component 128 may determine when a second wireless node (e.g., a UE) is scheduled to receive transmissions from other devices (i.e., remotely scheduled transmissions) based on the report 1010. The report component 128 may output timing information for the remote scheduled transmission to the indication component 124.

The indication component 124 may obtain the scheduling information from the scheduler component 1110 and obtain the remote scheduled transmissions from the report component 128. The indication component 124 may determine symbol locations associated with a gap 550 during which a phase jump 555 will occur in a transmission via multiple TTIs. That is, for the scheduled transmissions, the indication component 124 may determine whether the wireless node 1102 will begin transmitting another transmission, perform a Tx/Rx/Tx switch, perform an RF reconfiguration, or another operation that can cause a phase jump 555 during the gap 550 in the scheduled transmission. The indication component 124 may also determine whether the intended recipient of the scheduled transmission (e.g., second wireless node 1004) is likely to cause a phase jump, for example, due to a remote scheduled transmission, an Rx/Tx/Rx switch, or an RF reconfiguration. The indication component 124 is configured to output the indication 610 of one or more symbol locations associated with the gap 550 during which the phase jump 555 will occur in the transmission 510 via multiple TTIs. For instance, the indication component 124 may output the indication 610 for transmission via the transmitter component 1172 and/or the transceiver 1176.

The reference signal component 126 is configured to output, based on the gap, one or more additional reference signals located before or after the gap for estimating the phase jump during the gap. For example, the reference signal component 126 may output the reference signals according to the configuration 1020. For instance, the additional reference signals may be in addition to a DMRS according to a DMRS pattern and may include the gRS 710, 810 or the dynamic DMRS 910. The reference signal component 126 may be configured with a sequence generator that generates the sequence of the reference signal. In some implementations, the reference signal component 126 outputs the additional reference signals for transmission based on a signal from the indication component 124 that the phase jump 555 is present (e.g., when the indication component 124) outputs the indication 610.

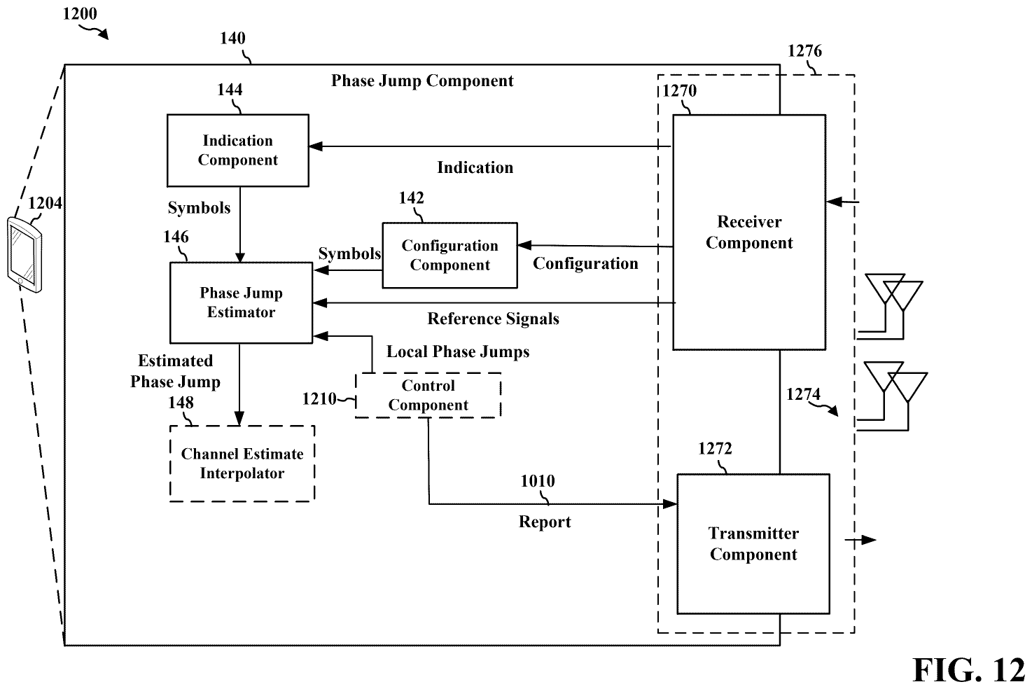

FIG. 12 is a conceptual data flow diagram 1200 illustrating the data flow between different means/components in an example UE 1204 including a phase jump component 140. For example, the UE 1204 may be an example of a wireless node such as the UE 104 (FIG. 1) including the phase jump component 140. The phase jump component 140 may be implemented by the memory 360 and the TX processor 368, the RX processor 356, and/or the controller/processor 368 of FIG. 3. For example, the memory 360 may store executable instructions defining the phase jump component 140 and the TX processor 368, the RX processor 356, and/or the controller/processor 359 may execute the instructions.

The UE 1204 may include a receiver component 1270, which may include, for example, a radio frequency (RF) receiver for receiving the signals described herein. The UE 1204 may include a transmitter component 1272, which may include, for example, an RF transmitter for transmitting the signals described herein. The transmitter component 1272 may output RF signals to one or more antennas 1274. In an aspect, the UE 1204 and the transmitter component 1272 may be co-located in a transceiver 1276, which may correspond to the TX/RX 354 in FIG. 3.

As discussed with respect to FIG. 1, the phase jump component 140 may include the configuration component 142 and the phase jump estimator 146. In some implementations, the phase jump component 140 may include the indication component 144, the channel estimate interpolator 148 and/or a control component 1210.

The receiver component 1270 may receive signals from a wireless node such as a network entity or another UE. For example, the receiver component 1270 may receive the configuration 1020, the indication 610, the PxSCH 526, 536, and reference signals such as the gRS 710, 720, 810 and the DMRS 524, 534, 910. The receiver component 1270 may output the configuration 1020 to the configuration component 142. The receiver component 1270 may output the indication 610 to the indication component 144. The receiver component 1270 may output the PxSCH 526, 536 to a demodulator. The receiver component 1270 may output the reference signals to the phase jump estimator 146.

The configuration component 142 is configured to obtain a configuration of one or more symbol locations of one or more reference signals before or after a gap during which a phase jump can occur in a transmission to be received via multiple TTIs, For example, the configuration component 142 may obtain the configuration 1020 via the receiver component 1270 and/or the transceiver 1276. The configuration component 142 may configure the receiver component 1270 t receive the reference signals such as the gRS 710, 720, 810 and the DMRS 910 on the configured symbols. The configuration component 142 may configure the phase jump estimator 146 with the symbols to use for estimating the phase jump.

In some implementations, the control component 1210 is configured to detect local phase jumps. As discussed above, phase jumps may be caused at a receiver due to Rx/Tx/Rx switching, RF reconfiguration, or scheduling of another reception (e.g., on a sidelink). The control component 1210 may output a report 1010 of the local phase jumps for transmission via the transmitter component 1272. For example, the report 1010 may be an RRC message. The control component 1210 may also output the local phase jumps (or corresponding symbols) to the phase jump estimator 146.

The indication component 144 may obtain the indication 610 via the receiver component 1270. The indication component 144 may identify the symbols where a gap 550 includes a phase jump 555 based on the indication 610. For example, the indication component 144 may apply the offset to a symbol in which the indication 610 was obtained. The indication component 144 may output the symbols to the phase jump estimator 146.

The phase jump estimator 146 is configured to estimate the phase jump during the gap based on one or more reference signals located before or after the gap. The phase jump estimator 146 may obtain the symbols corresponding to the gap from the indication component 144. In some implementations, the phase jump estimator 146 may obtain an indication of local phase jumps from the control component 1210. The phase jump estimator 146 may obtain reference signals such as the gRS 710, 720, 810 and/or the DMRS 524, 534, 910. The phase jump estimator 146 may select a last reference signal before the gap and a first reference signal after the gap for measuring a phase angle θ. The phase jump estimator 146 may estimate the phase jump as θ₁−θ₀, where θ₀ is measured on the last reference signal before the gap 550, and θ₁ is measured on the first reference signal after the gap 550. The phase jump estimator 146 may output the estimated phase jump to the channel estimate interpolator 148.

The channel estimate interpolator 148 is configured to interpolate a channel estimate based at least in part on the estimated phase jump. For example, the channel estimate interpolator 148 may compensate for the estimated phase jump when interpolating the channel estimate for each symbol. For instance, the channel state interpolator 148 may subtract the estimated phase jump when calculating the phase change per symbol due to Doppler. The channel estimate may be used to demodulate the symbols of the PxSCH 526, 536.

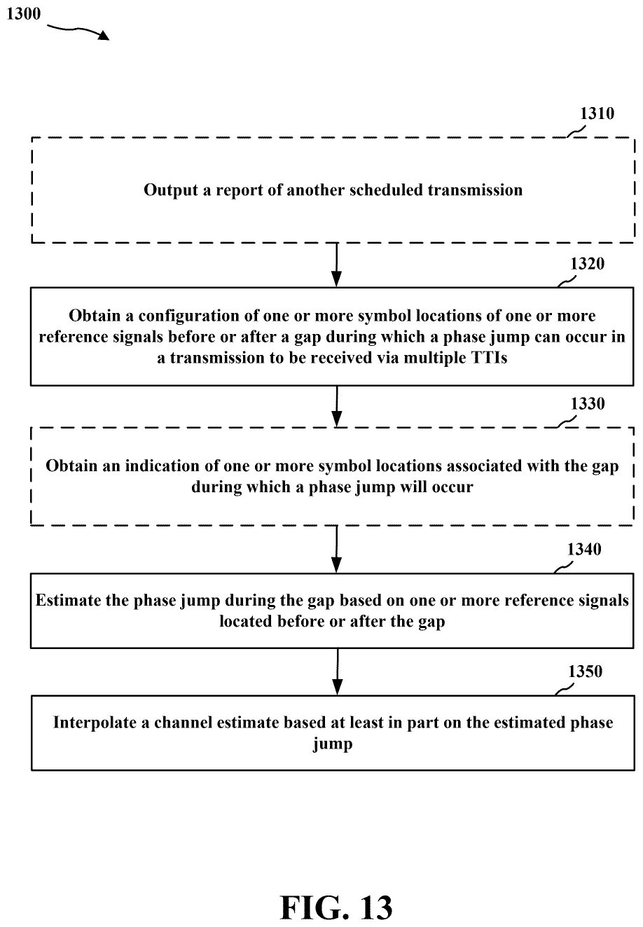

FIG. 13 is a flowchart of an example method 1300 for a wireless node such as a UE to compensate for a phase jump in a transmission obtained via multiple TTIs. The method 1300 may be performed by a UE (such as the UE 104, which may include the memory 360 and which may be the entire UE 104 or a component of the UE 104 such as the phase jump component 140, TX processor 368, the RX processor 356, or the controller/processor 359). The method 1300 may be performed by the phase jump component 140 in communication with the gap identification component 120 at another wireless node such as a network entity or another UE. Optional blocks are shown with dashed lines.

At block 1310, the method 1300 may optionally include outputting a report of another scheduled transmission. In some implementations, for example, the UE 104, the TX processor 368 or the controller/processor 359 may execute the phase jump component 140 or the control component 1210 to output a report 1010 of another scheduled transmission. Accordingly, the UE 104, the TX processor 368, or the controller/processor 359 executing the phase jump component 140 or the control component 1210 may provide means for outputting a report of another scheduled transmission.

At block 1320, the method 1300 includes obtaining a configuration of one or more symbol locations of one or more reference signals before or after a gap during which a phase jump can occur in a transmission to be received via multiple TTIs. In some implementations, for example, the UE 104, the RX processor 356 or the controller/processor 359 may execute the phase jump component 140 or the configuration component 142 to obtain the configuration 1020 of one or more symbol locations associated with a gap 550 during which a phase jump 555 can occur in a transmission 510 to be received via multiple TTIs. Accordingly, the UE 104, the RX processor 356, or the controller/processor 359 executing the phase jump component 140 or the configuration component 142 may provide means obtaining a configuration of one or more symbol locations of one or more reference signals before or after a gap during which a phase jump can occur in a transmission to be received via multiple TTIs.

At block 1330, the method 1300 may optionally include obtaining an indication of one or more symbol locations associated with a gap during which a phase jump will occur in a transmission to be received via multiple TTIs. In some implementations, for example, the UE 104, the RX processor 356 or the controller/processor 359 may execute the phase jump component 140 or the indication component 144 to obtain an indication 610 of one or more symbol locations associated with a gap 550 during which a phase jump 555 will occur in a transmission 510 to be received via multiple TTIs. In some implementations, the indication is within control information obtained in a TTI prior to the gap. For instance, the indication may include an offset with respect to the control information. Accordingly, the UE 104, the RX processor 356, or the controller/processor 359 executing the phase jump component 140 or the indication component 144 may provide means obtaining an indication of one or more symbol locations associated with a gap during which a phase jump will occur in a transmission to be received via multiple TTIs.

At block 1340, the method 1300 includes estimating the phase jump during the gap based on one or more reference signals located before or after the gap. In some implementations, for example, the UE 104, the RX processor 356 or the controller/processor 359 may execute the phase jump component 140 or the phase jump estimator 146 to estimate the phase jump 555 during the gap 550 based on one or more reference signals (e.g., gRS 710, 720, 810 or DMRS 524, 534, 910) located before or after the gap 550. In some implementations, the one or more reference signals located before or after the gap include a gRS 710, 720, 810 with a sequence based on a DMRS 524, 534 of the transmission 510 and a frequency domain pattern associated with fewer resource blocks than the DMRS. In some implementations, the gRS 710 is configured with a periodicity such that a quantity of symbols between the gRS 710 or the DMRS 524 before the gap 550 and a last symbol of the transmission before the gap is less than or equal to a threshold value. In some implementations, the gRS 810 is located in one or both of a last symbol of the transmission prior to the gap 550 and a first symbol of the transmission after the gap when the last symbol or the first symbol does not include the DMRS. In some implementations, the one or more reference signals located before or after the gap include a DMRS 910 that is dynamically indicated by the indication 610 of symbol locations associated with the gap. For instance, the DMRS 910 may follow an additional DMRS pattern (with respect to DMRS 524, 534) when the indication 610 indicates the DMRS 910. As another example, the indication 610 may further indicate an offset of the DMRS 910 with respect to the indication. Accordingly, the UE 104, the RX processor 356, or the controller/processor 359 executing the phase jump component 140 or the phase jump estimator 146 may provide means for estimating the phase jump during the gap based on one or more reference signals located before or after the gap.

At block 1350, the method 1300 may optionally include interpolating a channel estimate based at least in part on the estimated phase jump. In some implementations, for example, the UE 104, the RX processor 356 or the controller/processor 359 may execute the phase jump component 140 or the channel estimate interpolator 148 to interpolate a channel estimate based at least in part on the estimated phase jump. Accordingly, the UE 104, the RX processor 356, or the controller/processor 359 executing the phase jump component 140 or the channel estimate interpolator 148 may provide means for interpolating a channel estimate based at least in part on the estimated phase jump.

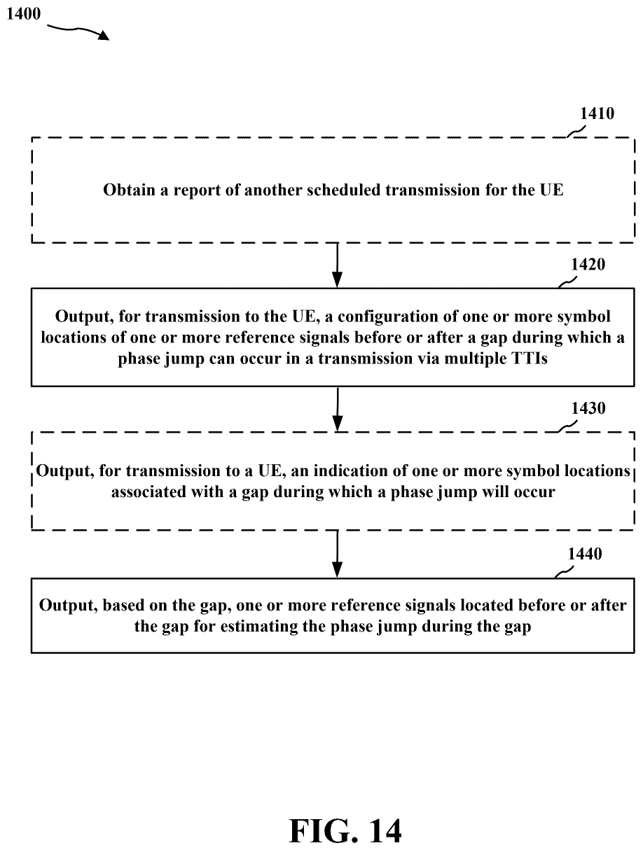

FIG. 14 is a flowchart of an example method 1400 for a wireless node such as a network entity to support phase jump compensation for transmissions via multiple TTIs. The method 1400 may be performed by a wireless node 1102 such as a base station (e.g., the base station 310, which may include the memory 376 and which may be the entire base station 102 or a component of the base station 102 such as the gap identification component 120, TX processor 316, RX processor 370, or the controller/processor 375). The method 1400 may be performed by the gap identification component 120 in communication with the phase jump component 140 at a UE. Optional blocks are shown with dashed lines.

At block 1410, the method 1400 may optionally include obtaining a report of another scheduled transmission for the UE. In some implementations, for example, the wireless node 1102, the RX processor 370, or the controller/processor 375 may execute the gap identification component 120 or the report component 128 to obtain the report 1010 of another scheduled transmission for the UE. Accordingly, the wireless node 1102, the RX processor 370, or the controller/processor 375 executing the gap identification component 120 or the report component 128 may provide means for obtaining a report of another scheduled transmission for the UE.

At block 1420, the method 1400 includes outputting, for transmission to UE, a configuration of one or more symbol locations of one or more reference signals before or after a gap during which a phase jump can occur in a transmission via multiple TTIs. In some implementations, for example, the wireless node 1102, the TX processor 316, or the controller/processor 375 may execute the gap identification component 120 or the configuration component 122 to output, for transmission to the UE, a configuration of one or more symbol locations of one or more reference signals before or after a gap 550 during which a phase jump 555 can occur in a transmission 510 via multiple TTIs (e.g., slots 520, 530). Accordingly, the wireless node 1102, the RX processor 370, or the controller/processor 375 executing the gap identification component 120 or the configuration component 122 may provide means for outputting, for transmission to UE, a configuration of one or more symbol locations of one or more reference signals before or after a gap during which a phase jump can occur in a transmission via multiple TTIs.

At block 1430, the method 1400 may optionally include outputting, for transmission to a UE, an indication of one or more symbol locations associated with a gap during which a phase jump will occur in a transmission over via multiple TTIs. In some implementations, for example, the wireless node 1102, the TX processor 316, or the controller/processor 375 may execute the gap identification component 120 or the indication component 124 to output, for transmission to the UE, an indication 610 of one or more symbol locations associated with a gap 550 during which a phase jump 555 will occur in a transmission 510 over via multiple TTIs. Accordingly, the wireless node 1102, the RX processor 370, or the controller/processor 375 executing the gap identification component 120 or indication component 124 may provide means for outputting, for transmission to a UE, an indication of one or more symbol locations associated with a gap during which a phase jump will occur in a transmission over via multiple TTIs.

At block 1440, the method 1400 includes outputting, based on the gap, one or more reference signals located before or after the gap for estimating the phase jump during the gap. In some implementations, for example, the wireless node 1102, the TX processor 316, or the controller/processor 375 may execute the gap identification component 120 or the reference signal component 126 to output, based on the gap, one or more reference signals (e.g., gRS 710, 720, 810 or DMRS 910) located before or after the gap 550 for estimating the phase jump 555 during the gap. Accordingly, the wireless node 1102, the TX processor 316, or the controller/processor 375 executing the gap identification component 120 or the reference signal component 126 may provide means for outputting, based on the gap, one or more reference signals located before or after the gap for estimating the phase jump during the gap.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

Means for estimating, means for interpolating, means for obtaining and/or means for outputting may include any of the various processors and/or memories shown in FIG. 3. Means for receiving and/or means for transmitting may include any of the various processors, memories, and/or transceivers shown in FIG. 3.

The following numbered clauses provide an overview of aspects of the present disclosure:

Clause 1. A method of wireless communications at a wireless node, comprising: obtaining a configuration of one or more symbol locations of one or more reference signals before or after a gap during which a phase jump can occur in a transmission to be received via multiple transmission time intervals (TTIs); and estimating the phase jump during the gap based on the one or more reference signals located in the one or more symbol locations before or after the gap.

Clause 2. The method of clause 1, further comprising obtaining an indication of one or more symbol locations associated with the gap during which a phase jump will occur, wherein the indication is within control information obtained in a TTI prior to the gap.

Clause 3. The method of clause 2, wherein the indication includes an offset with respect to the control information.

Clause 4. The method of any of clauses 1-3, further comprising outputting a report of another scheduled transmission, wherein the indication is obtained after outputting the report.

Clause 5. The method of any of clauses 1-4, wherein the one or more reference signals located before or after the gap include a glue reference signal (gRS) with a sequence based on a demodulation reference signal (DMRS) of the transmission and a frequency domain pattern associated with fewer resource blocks than the DMRS.

Clause 6. The method of clause 5, wherein the gRS is configured with one or more symbol locations such that a quantity of symbols between the gRS or the DMRS before the gap and a last symbol of the transmission before the gap is less than or equal to a threshold value.

Clause 7. The method of clause 5, wherein the gRS is located in one or both of a last symbol of the transmission prior to the gap and a first symbol of the transmission after the gap when the last symbol or the first symbol does not include the DMRS.

Clause 8. The method of any of clauses 1-7, wherein the one or more reference signals located before or after the gap include a demodulation reference signal (DMRS) dynamically also indicated by the indication of symbol locations of the gap.

Clause 9. The method of clause 8, wherein the DMRS follows a DMRS pattern.

Clause 10. The method of clause 8, wherein the indication further indicates an offset of the DMRS with respect to the indication.

Clause 11. The method of any of clauses 1-10, further comprising interpolating a channel estimate based at least in part on the estimated phase jump.

Clause 12: An apparatus for wireless communication, including means for performing a method in accordance with any one of clauses 1-11.

Clause 13: A non-transitory computer-readable medium including executable instructions that, when executed by a processor of an apparatus, cause the apparatus to perform a method in accordance with any one of clauses 1-11.

Clause 14: A computer program product embodied on a computer-readable storage medium including code for performing a method in accordance with any one of clauses 1-11.

Clause 15: A wireless node, including: at least one transceiver; one or more memories including instructions; and one or more processors configured to execute the instructions and cause the wireless node to perform a method in accordance with any one of clauses 1-11, wherein the at least one transceiver is configured to receive the configuration.

Clause 16. A method of wireless communications at a wireless node, comprising: outputting, for transmission to a user equipment (UE), a configuration of one or more symbol locations of one or more reference signals before or after a gap during which a phase jump can occur in a transmission via multiple transmission time intervals (TTIs); and outputting, based on the gap, one or more reference signals at the symbol locations before or after the gap for estimating the phase jump during the gap.

Clause 17. The method of clause 16, further comprising outputting, for transmission to the UE, an indication of one or more symbol locations associated with the gap during which the phase jump will occur, wherein the indication is within control information output for transmission within a TTI prior to the gap.

Clause 18. The method of clause 17, wherein the indication includes an offset with respect to the control information.

Clause 19. The method of any of clauses 16-18, further comprising obtaining a report of another scheduled transmission for the UE, wherein the indication is output after obtaining the report.

Clause 20. The method of any of clauses 16-19, wherein the one or more reference signals located before or after the gap include a glue reference signal (gRS) with a sequence based on a demodulation reference signal (DMRS) of the transmission and a frequency domain pattern associated with fewer resource blocks than the DMRS.

Clause 21. The method of clause 20, wherein the gRS is configured with one or more symbol locations such that a number of symbols between the gRS or the DMRS before the gap and a last symbol of the transmission before the gap is less than a threshold value.

Clause 22. The method of clause 20, wherein the gRS is located in one or both of a last symbol of the transmission prior to the gap and a first symbol of the transmission after the gap when the last symbol or the first symbol does not include the DMRS.

Clause 23. The method of any of clauses 16-22, wherein the one or more reference signals located before or after the gap include a demodulation reference signal (DMRS) dynamically also indicated by the indication of symbol locations of the gap.

Clause 24. The method of clause 23, wherein the DMRS follows a DMRS pattern when the indication indicates the DMRS.

Clause 25. The method of clause 23, wherein the indication further indicates an offset of the DMRS with respect to the indication.

Clause 26: An apparatus, including means for performing a method in accordance with any one of clauses 16-25.

Clause 27: A non-transitory computer-readable medium including executable instructions that, when executed by a processor of an apparatus, cause the apparatus to perform a method in accordance with any one of clauses 16-25.

Clause 28: A computer program product embodied on a computer-readable storage medium including code for performing a method in accordance with any one of clauses 16-25.

Clause 29: A wireless node, including: at least one transceiver; one or more memories including instructions; and one or more processors configured to execute the instructions and cause the wireless node to perform a method in accordance with any one of clauses 16-25, wherein the at least one transceiver is configured to transmit the configuration of one or more symbol locations of one or more reference signals before or after a gap during which a phase jump can occur.

As used herein, a phrase referring to “at least one of” a list of items refers to any combination of those items, including single members. As an example, “at least one of: a, b, or c” is intended to cover: a, b, c, a-b, a-c, b-c, a-b-c, a-a, b-b, c-c, a-a-b, etc. Similarly, as used herein, a phrase referring to “one or more of” a list of items refers to any combination of those items, including single members. As an example, “one or more of: a, b, or c” is intended to cover: a, b, c, a-b, a-c, b-c, a-b-c, a-a, b-b, c-c, a-a-b, etc.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories storing computer-executable instructions; and
one or more processors configured to execute the computer-executable instructions, individually or in combination, to cause the apparatus to:
obtain a configuration of one or more symbol locations of one or more reference signals before or after a gap during which a phase jump can occur in a transmission to be received via multiple transmission time intervals (TTIs); and
estimate the phase jump during the gap based on the one or more reference signals located in the one or more symbol locations before or after the gap.

2. The apparatus of claim 1, wherein the one or more processors, individually or in combination, are further configured to obtain an indication of one or more symbol locations associated with the gap during which a phase jump will occur, wherein the indication is within control information obtained in a TTI prior to the gap.

3. The apparatus of claim 2, wherein the indication includes an offset with respect to the control information.

4. The apparatus of claim 2, wherein the one or more processors, individually or in combination, are configured to output a report of another scheduled transmission, wherein the indication is obtained after outputting the report.

5. The apparatus of claim 1, wherein the one or more reference signals located before or after the gap include a glue reference signal (gRS) with a sequence based on a demodulation reference signal (DMRS) of the transmission and a frequency domain pattern associated with fewer resource blocks than the DMRS.

6. The apparatus of claim 5, wherein the gRS is configured with one or more symbol locations such that a quantity of symbols between the gRS or the DMRS before the gap and a last symbol of the transmission before the gap is less than or equal to a threshold value.

7. The apparatus of claim 5, wherein the gRS is located in one or both of a last symbol of the transmission prior to the gap and a first symbol of the transmission after the gap when the last symbol or the first symbol does not include the DMRS.

8. The apparatus of claim 1, wherein the one or more reference signals located before or after the gap include a demodulation reference signal (DMRS) dynamically indicated by the indication of symbol locations associated with the gap.

9. The apparatus of claim 8, wherein the DMRS follows a DMRS pattern when the indication indicates the DMRS.

10. The apparatus of claim 8, wherein the indication further indicates an offset of the DMRS with respect to the indication.

11. The apparatus of claim 1, wherein the one or more processors, individually or in combination, are configured to interpolate a channel estimate based at least in part on the estimated phase jump.

12. The apparatus of claim 1, further comprising a transceiver configured to receive the configuration, the one or more reference signals, and the transmission, wherein the apparatus is configured as a user equipment.

13. An apparatus for wireless communication, comprising:
one or more memories storing computer-executable instructions; and
one or more processors configured to execute the computer-executable instructions, individually or in combination, to cause the apparatus to:
output, for transmission to a user equipment (UE), a configuration of one or more symbol locations of one or more reference signals before or after a gap during which a phase jump can occur in a transmission via multiple transmission time intervals (TTIs); and
output, based on the gap, one or more reference signals at the symbol locations before or after the gap for estimating the phase jump during the gap.

14. The apparatus of claim 13, wherein the one or more processors, individually or in combination, are further configured to output, for transmission to the UE, an indication of one or more symbol locations associated with the gap during which the phase jump will occur, wherein the indication is within control information output for transmission within a TTI prior to the gap.

15. The apparatus of claim 14, wherein the indication includes an offset with respect to the control information.

16. The apparatus of claim 14, wherein the one or more processors, individually or in combination, are further configured to obtain a report of another scheduled transmission for the UE, wherein the indication is output after obtaining the report.

17. The apparatus of claim 13, wherein the one or more reference signals located before or after the gap include a glue reference signal (gRS) with a sequence based on a demodulation reference signal (DMRS) of the transmission and a frequency domain pattern associated with fewer resource blocks than the DMRS.

18. The apparatus of claim 17, wherein the gRS is configured with one or more symbol locations such that a quantity of symbols between the gRS or the DMRS before the gap and a last symbol of the transmission before the gap is less than or equal to a threshold value.

19. The apparatus of claim 17, wherein the gRS is located in one or both of a last symbol of the transmission prior to the gap and a first symbol of the transmission after the gap when the last symbol or the first symbol does not include the DMRS.

20. The apparatus of claim 13, wherein the one or more reference signals located before or after the gap include a demodulation reference signal (DMRS) dynamically also indicated by the indication of symbol locations of the gap.

21. The apparatus of claim 20, wherein the DMRS follows a DMRS pattern when the indication indicates the DMRS.

22. The apparatus of claim 20, wherein the indication further indicates an offset of the DMRS with respect to the indication.

23. The apparatus of claim 13, further comprising a transceiver configured to transmit the configuration, the transmission, and the one or more reference signals, wherein the apparatus is configured as a user equipment or a network node.

24. A method of wireless communications at a wireless node, comprising:
obtaining a configuration of one or more symbol locations of one or more reference signals before or after a gap during which a phase jump can occur in a transmission to be received via multiple transmission time intervals (TTIs); and
estimating the phase jump during the gap based on the one or more reference signals located in the one or more symbol locations before or after the gap.
